(19) United States
(12) Patent Application Publication
(10) Pub. No.: US 2021/0001837 A1
(43) Pub. Date: Jan. 7, 2021

(54) PARKING ASSIST DEVICE

(71) Applicant: HITACHI AUTOMOTIVE SYSTEMS, LTD., Hitachinaka-shi, Ibaraki (JP)

(72) Inventors: Keiichiro HIRAKAWA, Hitachinaka-shi (JP); Satoru OKUBO, Hitachinaka-shi (JP); Masashi SEIMIYA, Hitachinaka-shi (JP); Munetoshi TSUGE, Hitachinaka-shi (JP)

(73) Assignee: HITACHI AUTOMOTIVE SYSTEMS, LTD., Hitachinaka-shi, Ibaraki (JP)

(21) Appl. No.: 16/969,696

(22) PCT Filed: Jan. 11, 2019
(86) PCT No.: PCT/JP2019/000634

§ 371 Date: Aug. 13, 2020

(30) Foreign Application Priority Data
Feb. 14, 2018 (JP) 2018-024263

(51) Int. Cl. B60W 30/06; G01C 21/34; G01C 21/36; G08G 1/14; B60W 60/00

(52) U.S. Cl. CPC B60W 30/06; G01C 21/3415; G01C 21/3626; B60W 2420/54; B60W 60/001; B60W 2420/42; G08G 1/143

(57) ABSTRACT

There is a problem that it takes a long time to park a vehicle because the vehicle has to be returned to a position outside the parking frame and parked.

In step S160, the correction judgment unit 142 judges from the necessary correction amounts calculated in steps S140 and S150 and the remaining distance to the re-targeted parking position that is re-recognized, whether or not correction of the parking route with this remaining distance is possible. In a case where it is judged in step S160 that correction with the remaining distance r2 is impossible, the vehicle is stopped in step S171. Even if it is judged in step S160 that the correction is impossible, when the vehicle is moved backward toward the parking frame is parked, the vehicle is obliquely parked in the parking frame and cannot be fit neatly in the parking frame. In step S172, a parking route including a turnabout is regenerated with respect to the re-targeted parking position calculated in step S130 while the stopped state is maintained.

### TECHNICAL FIELD

The present invention relates to a parking assist device.

### BACKGROUND ART

Driving assist systems have been developed to prevent traffic accidents and to reduce driving loads on drivers during traffic congestion and the like. One example of the driving assist systems is parking assist. In parking assist, if the driver specifies a target parking frame, some or all of accelerator, brake and steering operations are automatically performed to park the vehicle in the target parking frame.

PTL 1 describes that in a case where a vehicle approaches a parking frame, a camera provided on a side of the vehicle re-recognizes the parking frame with high accuracy to correct the target parking position.

However, due to the positional relationship between the own-vehicle position and the parking-frame position when the parking frame is re-recognized, the remaining travel distance to the target parking position and the steering amount, and the like are limited, and the lateral position and the yaw angle that the vehicle can correct are limited. Therefore, in a case where the vehicle is parked toward the parking frame, the vehicle is obliquely parked in the parking frame and cannot be fit neatly in the parking frame. Since the lateral position and the yaw angle that can be corrected in a narrow range within the parking frame are limited, it is necessary to return the vehicle to the position outside the parking frame and then makes a turnabout so that the vehicle is neatly fit in the parking frame.

### CITATION LIST

### Patent Literature

PTL 1: JP 2008-285083 A

### SUMMARY OF INVENTION

### Technical Problem

In the device described in PTL 1 described above, the vehicle has to be returned to the position outside the parking frame and then parked, which causes a problem that it takes time to park the vehicle.

### Solution to Problem

A parking assist device according to the present invention includes a parking-frame recognition unit that recognizes a parking frame, a route generation unit that generates a route from a current position of a vehicle to a target parking position in the parking frame, a re-targeted parking position calculating unit that calculates a re-targeted parking position of the vehicle in a case where the vehicle approaches the parking frame with a predetermined distance therebetween, a correction calculation unit that calculates a necessary correction amount for the vehicle to reach the re-targeted parking position from a re-recognized position where the parking frame is re-recognized, a distance calculation unit that calculates a remaining distance from the re-recognized position to the re-target parking position, and a correction judgment unit that judges whether or not correction of the necessary correction amount with the remaining distance is possible, in which a parking route of the vehicle is changed according to judgment as to whether or not the correction is possible made by the correction judgment unit.

### Advantageous Effects of Invention

With the automatic parking assist process according to the present invention, there is no risk of obliquely parking a vehicle in a parking frame, and therefore, it is not necessary to move the vehicle obliquely parked in the parking frame to re-park the vehicle, and the time required for parking is can be shortened.

### BRIEF DESCRIPTION OF DRAWINGS

FIG. 1 is a system configuration diagram of a parking assist device.

FIG. 2 is a flowchart illustrating a parking assist process of a parking control unit.

FIG. 3 is a view illustrating a state of a vehicle located a predetermined distance before a parking frame.

FIGS. 4(a) and 4(b) are a view illustrating the state of the vehicle located the predetermined distance before the parking frame, and a partially enlarged view thereof, respectively.

### DESCRIPTION OF EMBODIMENTS

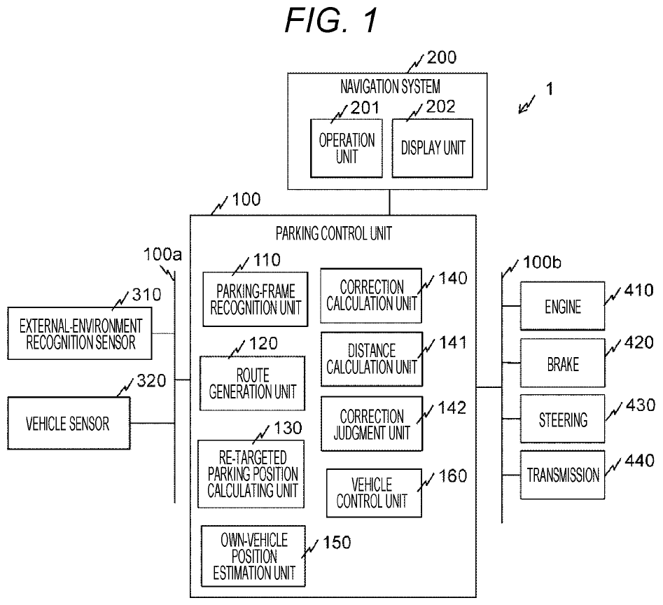

FIG. 1 is a system configuration diagram of a parking assist device 1.

The parking assist device 1 includes a parking control unit 100 and a navigation system 200. The parking assist device 1 further includes an external-environment recognition sensor 310 and a vehicle sensor 320, which are connected to the parking control unit 100 via an onboard network 100a. The parking assist device 1 further includes an engine 410, a brake 420, a steering 430, and a transmission 440 that are connected to the parking control unit 100 via an onboard network 100b.

The parking control unit 100 includes a parking-frame recognition unit 110, a route generation unit 120, a re-targeted parking position calculating unit 130, a correction calculation unit 140, a distance calculation unit 141, a correction judgment unit 142, an own-vehicle position estimation unit 150, and a vehicle control unit 160.

The parking-frame recognition unit 110 recognizes a parking space where a vehicle is to be parked on the basis of parking frame lines of a parking lot and or an adjacent vehicle parked in the parking lot detected by the external-environment recognition sensor 310 such as a camera or a sonar. There are three types of parking spaces of the embodiment, that is, a rectangular area surrounded by parking frame lines, a rectangular area surrounded by adjacent vehicles, and a rectangular area surrounded by both the parking frame lines and the adjacent vehicles. Therefore, each of the parking spaces is treated as a parking frame including a pair of short sides at the front end and the rear end corresponding to the front and rear ends of the vehicle, respectively, and a pair of right and left long sides corresponding to the right and left side ends of the vehicle, respectively.

The route generation unit 120 generates a parking route from the current position of the vehicle to the target parking position within the parking frame recognized by the parking-frame recognition unit 110. Note that a parking route can be generated not only when the vehicle stops but also when the vehicle is travelling. In particular, if the external-environment recognition sensor 310 has high accuracy, a parking route can be generated even while travelling. In addition, the target parking position is uniquely defined within the recognized parking frame.

In a case where the vehicle approaches one short side that constitutes the front end of the parking frame with a predetermined distance therebetween after an automatic parking control process is started and the vehicle starts travelling along the parking route from the initial position, the parking-frame recognition unit 110 re-recognizes the parking frame and the re-targeted parking position calculating unit 130 calculates the re-targeted parking position of the vehicle. Re-recognizing the parking frame means executing the process of re-recognizing the parking frame by the parking-frame recognition unit 110 when the vehicle approaches the parking frame with a predetermined distance therebetween.

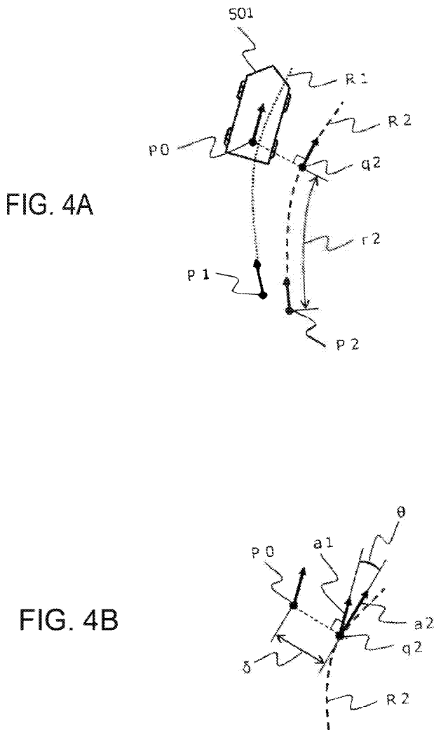

The correction calculation unit 140 calculates the necessary correction amount of the vehicle for reaching the re-targeted parking position from the re-recognized position where the parking frame is re-recognized. The necessary correction amount includes the lateral-position correction amount and the yaw-angle correction amount obtained from the current position and the attitude of the vehicle. That is, the necessary correction amount is a correction amount necessary for travelling again toward the re-parking target position on the basis of the initially set parking route and the parking route calculated after the re-targeted parking position is set. The necessary correction amount will be described later with reference to FIG. 4.

The distance calculation unit 141 calculates the remaining distance from the re-recognized position to the re-targeted parking position of the re-recognized parking frame. The remaining distance is the travel distance between the current position of the vehicle moving along the parking route and the re-parking target position. The remaining distance will be described later with reference to FIG. 4.

The correction judgment unit 142 judges whether or not correction of the necessary correction amount is possible with the calculated remaining distance. Specifically, the correction judgment unit 142 stores in advance the relationship between the remaining distance and the necessary correction amount that can be corrected, and judges whether or not the necessary correction amount calculated by the correction calculation unit 140 and the remaining distance calculated by the distance calculation unit 141 are within the range of the stored correction amount. This judgement process will be described in detail later.

Note that in a case where the correction judgment unit 142 judges that the correction is impossible, the route generation unit 120 generates a turnabout route to the re-targeted parking position. The process of generating the turnback route will be described in detail later.

The own-vehicle position estimation unit 150 estimates the current position of the vehicle from information of the vehicle sensor 320 such as a global positioning system (GPS), a global navigation satellite system (GNSS), a gyro sensor, or the like.

The vehicle control unit 160 controls various actuators as well as the engine 410, the transmission 440, and the like on the basis of the information from the vehicle sensor 320, the external-environment recognition sensor 310, and the like, and the vehicle enters or exits the parking lot by automatic driving. In the case of manual driving, the vehicle is controlled according to input of operation signals from the steering 430, the brake 420, or the like to advance or stop the vehicle.

The navigation system 200 includes an operation unit 201 that serves as a human machine interface and transmits and receives information between the navigation system 200 and the driver, and a display unit 202, and a parking route is displayed on the display unit 202.

The external-environment recognition sensor 310 is a camera, a sonar, or the like, and is installed, for example, in the front, the rear, and sides of the vehicle.

The parking-frame recognition unit 110 (1) recognizes a parking frame from the frame line position detected by the camera in a case where the parking frame is a parking space surrounded by the parking frame lines, in other words, in a case where no other vehicle is parked on both the right and left sides of the parking frame line, (2) recognizes the parking frame from the positions of the adjacent vehicles detected by the sonar, in a case where the parking frame is a parking space surrounded by the adjacent vehicles, in other words, the parking frame is not a parking space surrounded by the parking frame lines but is formed by the vehicles parked on the right and left sides, and (3) recognizes the parking frame from the parking frame lines detected by the cameras or the parking frame from the position information of the adjacent vehicles detected by the sonars in a case where the parking frame is a parking space surrounded by both the parking frame lines and the adjacent vehicles. In any of the cases (1) to (3), the parking frame is recognized and processed as a rectangular frame.

In addition, the parking-frame recognition unit 110 (1) recognizes the parking frame by the cameras and the sonars installed on the rear and the sides of the vehicle in a case where the vehicle is parked side by side in the parking frame backward or obliquely backward, and (2) recognize the parking frame with the cameras and the sonars installed on the front and the sides of the vehicle in a case where the vehicle is parked side by side in the parking frame forward or obliquely forward. The recognition processes of (1) and (2) are the processes of recognizing the parking frame on the basis of the detection signals of the cameras and the sonars installed on the front, rear, and the right and left sides of the vehicle. That is, the cameras and the sonars to be used may be selected if the user selects the parking method of (1) or (2) upon start of automatic parking, that is, upon parking assist activation operation.

Further, the parking-frame recognition unit 110 stops re-recognition of the parking frame by the cameras and re-recognizes the adjacent vehicles by the sonars in a case where the camera fails before the parking-frame recognition unit 110 starts the process of re-recognizing the parking frame as described above.

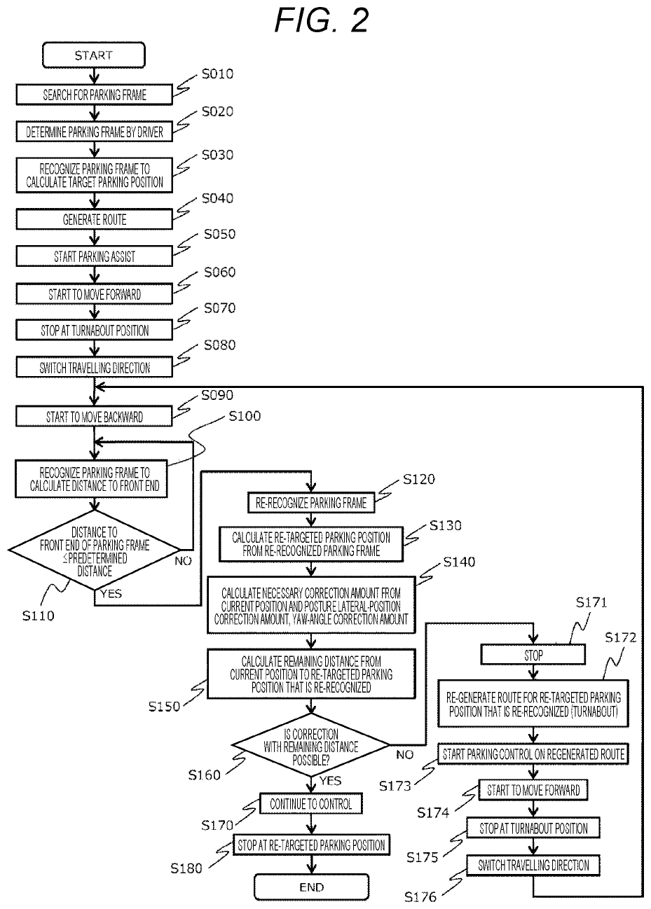

Next, operation of the present embodiment will be described with reference to FIGS. 2 to 4(b).

FIG. 2 is a flowchart illustrating the parking assist process of the parking control unit 100. Note that the program illustrated in this flowchart can be executed by a computer including a CPU, a memory, and the like. All or some of the processes may be realized by a hard logic circuit. This program can be stored in the storage medium of the parking control unit 100 in advance and provided. Alternatively, the program may be stored in an independent recording medium and provided, or the program may be recorded and stored in the storage medium of the parking control unit 100 via a network line.

In the flowchart illustrated in FIG. 2, side-by-side backward parking in which the vehicle moves forward with the parking position on the side of the vehicle, then makes a turnabout, and the vehicle enters the parking frame while moving backward is described as an example.

In step S010, the parking assist device 1 causes the parking-frame recognition unit 110 to start to search for a parking frame where the vehicle can be parked upon parking assist activation operation performed by the driver input from the operation unit 201 of the navigation system 200. The parking-frame recognition unit 110 detects a parking space in which the own vehicle can be parked, by using information such as the parking frame lines or adjacent vehicles obtained from the external-environment recognition sensor 310. The parking frame searched for in step S010 is displayed on the display unit 202 of the navigation system 200.

In step S020, the driver selects and determines a desired parking frame by using the operation unit 201 of the navigation system 200.

In step S030, a target parking position is calculated for the parking frame determined in step S020. The target parking position is information on the position where the vehicle should be parked in the parking frame determined by the driver; however, information on the yaw angle at the current position of the vehicle is also acquired. This target parking position is calculated from the relationship between the current position of the vehicle and the recognized parking frame.

In step S040, the route generation unit 120 generates a parking route for the target parking position calculated in step S030. If generation of the parking route is completed, the parking assist can be started. In step S050, vehicle control for parking by automatic driving is started upon parking assist start operation performed by the driver input from the operation unit 201 of the navigation system 200.

In step S060, under the control of the vehicle control unit 160, the vehicle moves forward to the turnabout position according to the parking route calculated in step S040. In step S070, the vehicle is stopped at the turnabout position. Next, in step S080, the travelling direction is switched to backward. Then, in step S090, backward movement is started.

If the backward movement is started in step S090, in step S100, the vehicle moves backward while calculating the distance between the own-vehicle position and the front end of the parking frame. The distance to the front end of the parking frame is calculated on the basis of the recognition result of the parking-frame recognition unit 110. Note that since the distance from the parking frame is often long immediately after start of the backward movement, the distance to the front end of the parking frame may be calculated on the basis of the parking route calculated in step S040 and information of the own-vehicle position acquired by the own-vehicle position estimation unit 150.

In step S110, it is judged whether or not the distance calculated in step S100 is equal to or less than a predetermined distance. The predetermined distance is, for example, a predetermined distance that is equal to or less than the distance from the turnabout position to the front end of the parking frame, and varies depending on the accuracy of the external-environment recognition sensor 310 or the like. If the distance is not equal to or less than the predetermined distance in step S110, the process returns to step S100, the vehicle continues to move backward toward the parking frame, and calculates the distance between the own-vehicle position and the front end of the parking frame. In step S110, if the distance is equal to or less than the predetermined distance, the process proceeds to step S120.

In step S120, the parking-frame recognition unit 110 re-recognizes the parking frame that the vehicle has approached with the predetermined distance therebetween. That is, the parking-frame recognition unit 110 detects a parking space in which the own vehicle can be parked, by using information such as the parking frame lines or the adjacent vehicles obtained from the external-environment recognition sensor 310.

In the next step S130, the re-targeted parking position is calculated from the re-recognized parking frame. The re-targeted parking position is calculated on the basis of the relationship between the current position of the vehicle and the recognized parking frame, and is information of the position where the vehicle should be parked. Similarly to step S030, the yaw angle information of the vehicle at this time point is also acquired.

In the next step S140, the correction calculation unit 140 calculates the correction amount necessary for parking the vehicle at the re-targeted parking position (x′, y′, θ′) calculated in step S130 from the current own-vehicle position (xc, yc) and the yaw angle (θc). The correction amount includes the lateral-position correction amount and the yaw-angle correction amount acquired from the current position and the attitude of the vehicle.

In step S150, the distance calculation unit 141 calculates the remaining distance from the current own-vehicle position to the re-targeted parking position calculated in step S130.

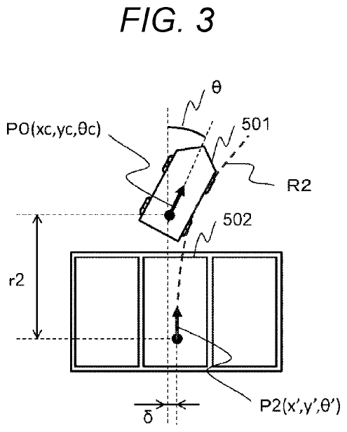

FIG. 3 is a view illustrating a state of a vehicle 501 located a predetermined distance before a parking frame 502. The processes of steps S120 to S150 will be described with reference to FIG. 3.

The vehicle 501 at an own-vehicle position P0 re-recognizes the parking frame in step S120. Then, a re-targeted parking position P2 is calculated on the basis of the parking frame re-recognized in step S130.

Then, on the basis of the own-vehicle position P0 (xc, yc, 6c) and the re-targeted parking position P2 (x′, y′, θ′), in step S140, the lateral-position correction amount δ and the yaw-angle correction amount θ are calculated by coordinate calculation. Here, it is assumed that the corrected route corrected by the re-targeted parking position P2 is R2.

In addition, the remaining distance r2 to the re-targeted parking position P2 that is re-recognized is calculated in step S150 from the own-vehicle position P0 (xc, yc, θc) and the re-targeted parking position P2 (x′, y′, θ′). The remaining distance r2 may be calculated as the distance between two points of the own-vehicle position P0 (xc, yc, θc) and the re-targeted parking position P2 (x′, y′, θ′).

Calculation of the lateral-position correction amount δ and the yaw-angle correction amount θ in step S140, and calculation of the remaining distance r2 to the re-targeted parking position P2 that is re-recognized in step S150 may also be performed on the basis of the corrected route R2, for example. A calculation example in this case will be described with reference to FIGS. 4(a) and 4(b). FIG. 4(a) is a view illustrating a state of the vehicle 501 located a predetermined distance before the parking frame, and FIG. 4(b) is a partially enlarged view thereof.

While the vehicle 501 is being controlled according to the parking route R1 with respect to the target parking position P1, the parking frame is re-recognized in step S120, and the re-targeted parking position P2 is calculated in step S130. In calculation of the parking route during travelling, in a case where calculation equivalent to route generation performed while the vehicle is stopped cannot be performed in step S040, a parking route R2 of passing through the re-targeted parking position P2 is obtained by using a simple method such as shifting the existing parking route R1, or the like. As illustrated in FIG. 4(a), a perpendicular line is drawn from the current own-vehicle position P0 to the corrected route R2. Then, as illustrated in FIG. 4(b), the distance between an intersection q2 and the own-vehicle position P0 is set as a lateral position correction amount δ.

Note that in the embodiment, δ=xc−x′ is satisfied because the Cartesian coordinates with the vertical direction in FIG. 3 as the Y axis and the horizontal direction in FIG. 3 as the X axis is used.

Further, the difference between a target yaw angle a2 of the corrected route R2 at the intersection q2 (inclination of the corrected route R2 relative to the Y axis at a position q2 of the correction route R2) and a yaw angle a1 of the current own-vehicle position (inclination of the parking route R1 relative to the Y axis at the position P0 of the parking route R1) is set to a yaw angle correction amount θ. Further, the remaining distance r2 to the re-targeted parking position P2 that is re-recognized is set to the route length between the intersection q2 and the target parking position P2.

As described above, the lateral-position correction amount δ, the yaw-angle correction amount θ, and the remaining distance r2 can also be obtained on the basis of the corrected route R2.

The description will be returned to the description of the flowchart in FIG. 2.

In step S160, the correction judgment unit 142 judges from the necessary correction amounts calculated in steps S140 and S150 and the remaining distance to the re-targeted parking position that is re-recognized, whether or not correction of the parking route with this remaining distance is possible.

In step S160, for example, the lateral position correctable amount and the yaw angle correctable amount for the travel distance of the vehicle 501 are stored in advance in a map, and it is judged whether or not correction with the remaining distance r2 is possible according to whether or not the calculated remaining distance, the calculated lateral-position correction amount and the calculated yaw-angle correction amount are within the correctable amounts stored in advance.

In a case where it is judged in step S160 that correction with the remaining distance r2 is possible, the process proceeds to step S170. In step S170, control is continued for the re-targeted parking position that is re-recognized, and the vehicle is moved backward. Then, in step S180, the vehicle is stopped at the re-targeted parking position that is re-recognized to complete the parking assist.

In contrast, in a case where it is judged in step S160 that correction with the remaining distance r2 is impossible, the vehicle is stopped in step S171. Even if it is judged that correction is impossible in step S160, in a case where the vehicle moves backward toward the parking frame and is parked, there is a problem that the vehicle is obliquely parked in the parking frame and cannot be fit neatly in the parking frame.

Therefore, in step S172, while the stopped state is maintained, with respect to the re-targeted parking position calculated in step S130, the parking route including a turnabout (a route to the corrected route R2 in FIG. 3, but the turnabout route is not illustrated) is regenerated. At this time, the display unit 202 may inform the driver of the reason why the vehicle has stopped (the fact that a turnabout is necessary) so as to confirm with the driver whether or not parking assist is to be carried out by using the regenerated route. In a case where parking assist is not carried out, manual driving is performed.

Next, in step S173, vehicle control is started according to the turnabout route regenerated in step S172. Then, in step S174, the vehicle is moved forward, and in step S175, the vehicle is stopped at the turnabout position of the regenerated turnabout route. Then, in step S176, the travelling direction is switched to backward. Then, the process returns to step S090 to start backward movement. The processes after step S100 are executed again, the vehicle is controlled to the latest re-targeted parking position calculated in step S130, and the vehicle is stopped at the re-targeted parking position by the processes of steps S160, S170, and S180.

In the above-described embodiment, the side-by-side backward parking is described as an example; however, the same applies to oblique backward parking, side-by-side forward parking, oblique forward parking, and the like. That is, in a case where the vehicle approaches the parking frame with a predetermined distance therebetween, the necessary correction amount of the vehicle for reaching the re-targeted parking position from the re-recognized position where the parking frame is re-recognized is calculated. If correction of the necessary correction amount cannot be performed with the remaining distance from the re-recognized position to the re-targeted parking position, a turnabout route to the re-targeted parking position is regenerated.

According to the present embodiment, the time required for parking can be shortened as compared with the case where the vehicle is temporarily returned to the position outside the parking frame and then the vehicle is fitted in the parking frame.

According to the embodiment described above, the following operational effects can be obtained. (1) The parking assist device 1 includes the parking-frame recognition unit 110 that recognizes a parking frame, the route generation unit 120 that generates the route from the current position P0 of the vehicle to the target parking position P1 in the parking frame, the re-targeted parking position calculating unit 130 that causes the parking-frame recognition unit 110 to re-recognize the parking frame and calculates the re-targeted parking position P2 of the vehicle in a case where the vehicle approaches the parking frame with a predetermined distance therebetween, and the correction calculation unit 140 that calculates necessary correction amounts δ, θ for the vehicle to reach the re-targeted parking position P2 from the re-recognized position P0 where the parking frame is re-recognized, the distance calculation unit 141 that calculates the remaining distance r2 from the re-recognized parking position P0 to the re-targeted parking position P2, and the correction judgment unit 142 that judges whether or not correction with the remaining distance r2 is possible, in which the parking route R1 of the vehicle is changed to the corrected route R2 according to judgment as to whether or not correction is possible made by the correction judgment unit 142.

In the parking assist device 1 of the embodiment configured as described above, in a case where the correction judgment unit 142 judges that the correction of the necessary correction amount is impossible, it is possible to determine in advance whether the vehicle is parked manually or the route to the re-targeted parking position is reset to continue automatic parking. As a result, it is possible to avoid wasteful travelling such as forward movement, a turnabout, and backward movement made in order to change the parking attitude after the vehicle is obliquely parked in the parking frame. As a result, the time required for parking can be shortened.

(2) In the parking assist device 1 according to (1), the correction judgment unit 142 judges whether or not the correction is possible on the basis of the relationship between the remaining distance r2 and the necessary correction amounts δ, θ stored in advance. As a result, it is possible to appropriately judge whether or not the correction with the remaining distance r2 is possible and reduce the time required for parking.

(3) In the parking assist device 1 according to (1) or (2), the route generation unit 120 regenerates the turnabout route R2 to the re-targeted parking position P2 in a case where the correction judgment unit 142 judges that the correction is impossible. As a result, the time required for parking can be shortened in a case where the correction with the remaining distance is impossible.

(4) The parking assist device 1 according to (3) includes the navigation system 200 that displays the route R2 generated and selects a route for travelling. The route generation unit 120 informs the navigation system 200 whether or not parking assist to the re-targeted parking position P2 regenerated is to be performed. Upon receiving this notification, the navigation system 200 outputs inquiry information as to whether or not to carry out parking assist on a screen or by voice. As a result, the driver can select whether or not to carry out parking assist in a case where correction with the remaining distance is impossible.

(5) In the parking assist device 1 according to (1), the parking-frame recognition unit 110 recognizes the parking frame from the frame line position detected by the cameras in a case where the parking frame is a parking space surrounded by the parking frame lines, recognizes the parking frame from the position of the adjacent vehicles detected by the sonars in a case where the parking frame is a parking space surrounded by the adjacent vehicles, and recognizes the parking frame from the frame line position detected by the cameras or the parking frame is recognized from the positions of the adjacent vehicles detected by the sonars in a case where the parking frame is surrounded by both the parking frame lines and the adjacent vehicles. As a result, it is possible to properly provide parking assist.

(6) In the parking assist device 1 according to (1), the parking-frame recognition unit 110 recognizes the parking frame by the cameras and the sonars installed on the rear and the sides of the vehicle in a case where the vehicle is parked side by side in the parking frame backward or obliquely backward, and recognizes the parking frame with the cameras and the sonars installed on the front and the sides of the vehicle in a case where the vehicle is parked side by side in the parking frame forward or obliquely forward. As a result, it is possible to properly provide parking assist.

(7) In the parking assist device 1 according to (1), the parking-frame recognition unit 110 stops the re-recognition of the parking frame by the cameras and re-recognizes the adjacent vehicles by the sonars in a case where the camera fails before the re-recognition of the parking frame. As a result, it is possible to properly provide parking assist.

The present invention is not limited to the above-described embodiment, and other modes conceivable within the scope of the technical idea of the present invention are also included in the scope of the present invention as long as the characteristics of the present invention are not impaired.

### REFERENCE SIGNS LIST

100 parking control unit
110 parking-frame recognition unit
120 route generation unit
130 re-targeted parking position calculating unit
140 correction calculation unit
141 distance calculation unit
142 correction judgment unit
150 own-vehicle position estimation unit
160 vehicle control unit
200 navigation system
201 operation unit
202 display unit
310 external-environment recognition sensor
320 vehicle sensor
410 engine
420 brake
430 steering
440 transmission

1. A parking assist device comprising:
a parking-frame recognition unit that recognizes a parking frame;
a route generation unit that generates a route from a current position of a vehicle to a target parking position in the parking frame;
a re-targeted parking position calculating unit that causes the parking-frame recognition unit to re-recognize the parking frame and calculates a re-targeted parking position of the vehicle in a case where the vehicle approaches the parking frame with a predetermined distance therebetween;
a correction calculation unit that calculates a necessary correction amount for the vehicle to reach the re-targeted parking position from a re-recognized position where the parking frame is re-recognized;
a distance calculation unit that calculates a remaining distance from the re-recognized position to the re-targeted parking position; and
a correction judgment unit that judges whether or not correction of the necessary correction amount with the remaining distance calculated is possible,
wherein a parking route of the vehicle is changed according to judgement as to whether or not the correction is possible made by the correction judgment unit.

2. The parking assist device according to claim 1, wherein the correction judgment unit judges whether or not the correction is possible on a basis of relationship between a remaining distance and a necessary correction amount stored in advance.

3. The parking assist device according to claim 1, wherein the route generation unit regenerates a turnabout route to the re-targeted parking position in a case where the correction judgment unit judges that the correction is impossible.

4. The parking assist device according to claim 3 further comprising
an interface unit that displays the route generated and selects a travelling route,
wherein in a case where the interface unit receives a parking route to the re-targeted parking position regenerated by the route generation unit, the interface unit presents inquiry information as to whether or not to perform parking assist to the re-targeted parking position.

5. The parking assist device according to claim 1, wherein
the parking-frame recognition unit
recognizes the parking frame from a frame line position detected by a camera in a case where the parking frame is a parking space surrounded by a parking frame line,
recognizes the parking frame from a position of an adjacent vehicle detected by a sonar in a case where the parking frame is a parking space surrounded by an adjacent vehicle, and
recognizes the parking frame from a frame line position detected by the camera or recognizes the parking frame from a position of the adjacent vehicle detected by the sonar in a case where the parking frame is a parking space surrounded by both the parking frame line and the adjacent vehicle.

6. The parking assist device according to claim 1, wherein
the parking-frame recognition unit
recognizes the parking frame by a camera and a sonar installed on a rear and a side of the vehicle in a case where the vehicle is parked side by side in the parking frame backward or obliquely backward, and
recognizes the parking frame with a camera and a sonar installed on a front and on the side of the vehicle in a case where the vehicle is parked side by side in the parking frame forward or obliquely forward.

7. The parking assist device according to claim 1, wherein the parking-frame recognition unit stops re-recognition of the parking frame by a camera and re-recognizes an adjacent vehicle by a sonar in a case where the camera fails before the re-recognition of the parking frame.
